(19) United States
(12) Patent Application Publication
(10) Pub. No.: US 2013/0345936 A1
(43) Pub. Date: Dec. 26, 2013

(54) Ride Control System for a Machine

(71) Applicants: Joshua Callaway, Cary, NC (US); Jay Holloman Renfrow, Kenly, NC (US); Christopher Erik Bright, Raleigh, NC (US)

(72) Inventors: Joshua Callaway, Cary, NC (US); Jay Holloman Renfrow, Kenly, NC (US); Christopher Erik Bright, Raleigh, NC (US)

(73) Assignee: CATERPILLAR INC., Peoria, IL (US)

(21) Appl. No.: 13/530,788

(22) Filed: Jun. 22, 2012

(51) Int. Cl. G06F 19/00

(52) U.S. Cl. 701/50

(57) ABSTRACT

A system for automated control of movement of a machine includes a pitch rate sensor to indicate the pitch rate of the machine. The machine has an implement movable relative to the machine. A controller generates a command signal to move the implement to control the pitch rate of the machine. A method is also provided.

### TECHNICAL FIELD

This disclosure relates generally to controlling a machine and, more particularly, to a control system for moving an implement to improve the ride of the machine.

### BACKGROUND

Machines with various implements are used in many industries and applications including those involving materials handling, construction, agriculture, forestry, mining, and the like. These machines generally do not include shock-absorbing suspension systems so that, as the machine is travelling, forces exerted on the machine by the terrain cause the vehicle to pitch and/or bounce which may result in operator discomfort and increased wear on the machine.

Ride control systems have been developed to improve the operation and comfort of the machines as they move along terrain and obstacles. Machines that include a hydraulic system to move and control a work implement may also include one or more accumulators within such hydraulic system. Such accumulators are often used to control relative movement between the machine and the implement to improve the ride of the machine. In some configurations, the accumulators may be selectively isolated from hydraulic circuitry of the hydraulic system.

U.S. Patent Publication No. 2010/0051298 A1 discloses a system for detecting and dissipating hydraulic spikes in pressure caused when implements of a machine bounce. The pressure spikes are dissipated by generating random or canceling pulses within the hydraulic system.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

In one aspect, a system for automated control of movement of a machine includes an implement configured for movement relative to the machine, a system for moving the implement relative to the machine, and a pitch rate sensor configured to provide a pitch rate signal indicative of a pitch rate of the machine. A controller is configured to receive the pitch rate signal from the pitch rate sensor and determine a pitch rate of the machine based upon the pitch rate signal. The controller is further configured to generate a command signal to move the implement at least in part based upon the pitch rate to control the pitch rate of the machine, and transmit the command signal to control movement of the implement and to control the pitch rate of the machine.

In another aspect, a machine has an implement configured for movement relative to the machine, a system for moving the implement relative to the machine, and a pitch rate sensor configured to provide a pitch rate signal indicative of a pitch rate of the machine. A controller implemented method includes receiving the pitch rate signal from the pitch rate sensor, and determining a pitch rate of the machine based upon the pitch rate signal. A command signal is generated to move the implement at least in part based upon the pitch rate to control the pitch rate of the machine, and the command signal is transmitted to control movement of the implement and to control the pitch rate of the machine.

In still another aspect, a machine includes a prime mover, an implement configured for movement relative to the machine, a system for moving the implement relative to the machine, and a pitch rate sensor configured to provide a pitch rate signal indicative of a measured pitch rate of the machine. A controller is configured to receive the pitch rate signal from the pitch rate sensor and determine a pitch rate of the machine based upon the pitch rate signal. The controller is further configured to generate a command signal to move the implement at least in part based upon the pitch rate to control the pitch rate of the machine, and transmit the command signal to control movement of the implement and to control the pitch rate of the machine.

### BRIEF DESCRIPTION OF THE DRAWINGS

FIG. 1 is a side elevational view of a machine constructed in accordance with the disclosure;

FIG. 2 is a block diagram of a ride control system in accordance with the disclosure; and

FIG. 3 is a flowchart illustrating a ride control process in accordance with the disclosure.

### DETAILED DESCRIPTION

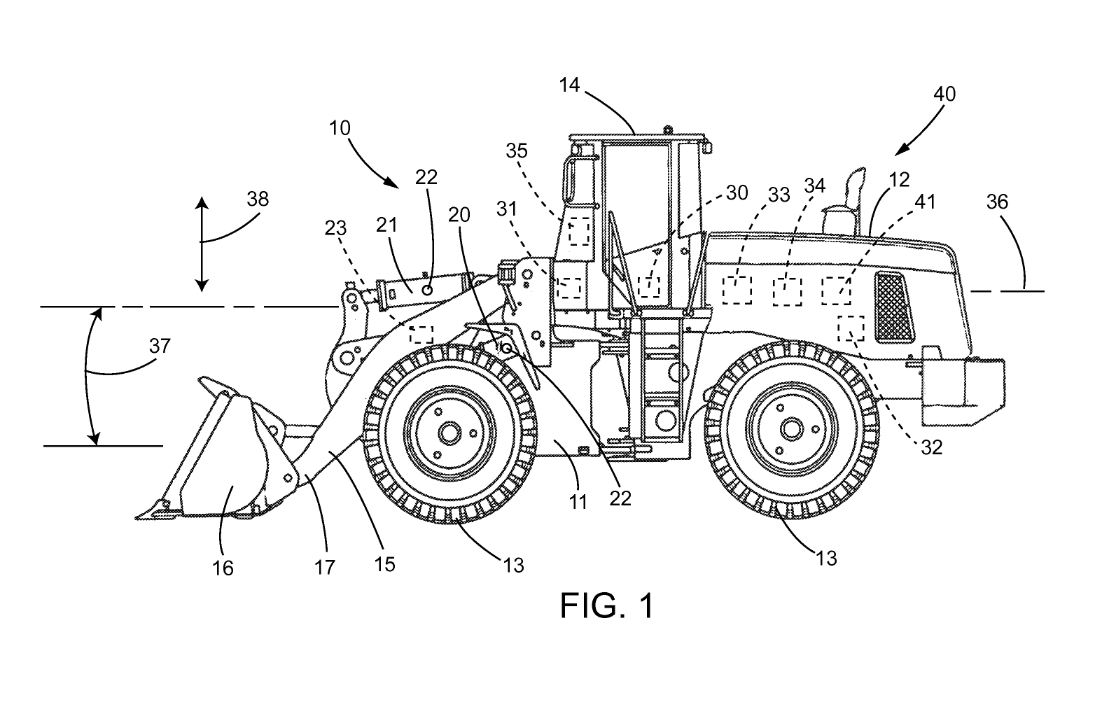

FIG. 1 is a diagrammatic illustration of machine 10 such as a wheel loader that may be used in accordance with an embodiment of the disclosure. While the machine 10 is depicted as a wheel loader, it is to be understood that the teachings of this disclosure apply to many other machines including both “wheeled” and “track-type” configurations. The machine 10 may include a chassis 11 and a prime mover such as an engine 12. The chassis 11 may be supported by wheels 13 that are operatively driven, directly or indirectly, by the engine 12. The chassis 11 may also support an operator station or cab 14, and one or more lift arms 15 pivotally connected to the chassis 11. An implement 16 configured for movement relative to the machine may be provided at a distal end 17 of the lift arms 15. Implement 16 may be any type of implement such as a ground engaging implement (e.g., a bucket) or an implement that may not engage the ground (e.g., a fork arrangement).

The machine may include a system such as an electro-hydraulic system for moving the implement relative to the machine. More specifically, one or more lift cylinders 20 may operatively connect the chassis 11 to the lift arms 15 to facilitate raising and lowering of the lift arms 14. One lift cylinder 20 may be provided for each lift arm 15, if desired. The lift cylinders 20 may be hydraulic cylinders operatively connected to the hydraulic system (not shown) of the loader 10. One or more tilt cylinders 21 may operatively connect the implement 16 to the chassis 11 to facilitate rotation of the implement 16 relative to the lift arms 15. The tilt cylinders 21 may be hydraulic cylinders operatively connected to the hydraulic system.

Machine 10 may be equipped with a plurality of sensors that provide data indicative, directly or indirectly, of the performance or conditions of various aspects of the machine. An operator presence sensor 30 may be provided to sense whether an operator is seated within the cab 14. A parking brake sensor 31 may be provided to sense whether the parking brake is engaged. A wheel speed sensor 32 may be provided to sense the speed of the wheels 13 and thus indicate the ground speed of the machine 10.

One or more sensors may be provided for sensing the movement of the machine 10. In one embodiment, a first sensor 33 such as a pitch rate sensor (e.g., a gyroscope) may be provided on the machine 10. The first sensor 33 may be used to provide a pitch rate signal indicative of a pitch rate of the machine 10. As the machine 10 moves, the pitch rate will be indicative of the rate of change of the pitch angle of the machine. The pitch angle of machine 10 is the angle of the machine relative to a horizontal centerline 36 through the machine and is depicted by arrow 37 in FIG. 1.

A second sensor 34 such as an acceleration sensor (e.g., a 3-axis accelerometer) may be provided on machine 10. The second sensor 34 may be used to provide an acceleration signal indicative of vertical acceleration of the machine 10 relative to a gravity reference. The vertical acceleration is depicted by arrow 38 in FIG. 1. By monitoring the acceleration at the second sensor 34, vertical movement of the machine 10 may be detected. First sensor 33 and second sensor 34 may be positioned on the chassis 11 of the machine 10.

In another configuration, the first sensor 33 and second sensor 34 may be positioned on a frame member of the implement 16 of the machine 10.

One or more sensors may be provided for sensing the load on or within the implement 16. In one embodiment, one or more hydraulic pressure sensors 22 may be associated with some or all of the hydraulic cylinders that are used to control the implement 16. By monitoring the pressure and pressure changes in the hydraulic cylinders, specific pressure characteristics may be monitored that are indicative of the load on or within the implement 16. Other types of sensors are also contemplated. In one example, the weight of the implement 16 such as a bucket will be known in an unloaded state. By monitoring the pressure and pressure changes within one or more of the hydraulic cylinders associated with the implement 16, the load within the implement may be determined.

One or more position sensors 23 may be provided for determining the position of the implement 16 relative to the machine 10. In one embodiment, the position sensors 23 may be rotary potentiometers associated with the pivot joints between the machine 10, the lift arms 15 and the implement 16. In another example, sensors may be associated with the hydraulic cylinders to determine the displacement of each cylinder. The displacement of the cylinders may be used to determine the position of the implement 16. Other types of sensors are also contemplated.

A control system 40 may be provided to control the operation of the machine 10 including the ride control aspects or functionality of the machine. The control system 40, as shown generally by an arrow in FIG. 1 indicating association with the machine 10, may include an electronic control module such as controller 41. The controller 41 may receive operator input command signals and control the operation of the various systems of the machine 10. The controller 41 is shown in FIG. 1 residing on the chassis 11 but may be mounted at any convenient location on machine 10. The control system 40 may include one or more input devices (not shown) to control the machine 10 and one or more sensors, including the operator presence sensor 30, the parking brake sensor 31, the wheel speed sensor 32, the first sensor 33 and the second sensor 34 to provide data and other input signals representative of various operating parameters of the machine 10.

The controller 41 may be an electronic controller that operates in a logical fashion to perform operations, execute control algorithms, store and retrieve data and other desired operations. The controller 41 may include or access memory, secondary storage devices, processors, and any other components for running an application. The memory and secondary storage devices may be in the form of read-only memory (ROM) or random access memory (RAM) or integrated circuitry that is accessible by the controller. Various other circuits may be associated with the controller such as power supply circuitry, signal conditioning circuitry, driver circuitry, and other types of circuitry.

The controller 41 may be a single controller or may include more than one controller disposed to control various functions and/or features of the machine 10. The term “controller” is meant to be used in its broadest sense to include one or more controllers and/or microprocessors that may be associated with the machine 10 and that may cooperate in controlling various functions and operations of the machine. The functionality of the controller 41 may be implemented in hardware and/or software without regard to the functionality. The controller 41 may rely on one or more data maps relating to the operating conditions of the machine 10 that may be stored in the memory of controller. Each of these maps may include a collection of data in the form of tables, graphs, and/or equations. The controller 41 may use the data maps to maximize the performance and efficiency of the machine 10.

The control system 40 may include a ride control system or functionality for assisting in controlling certain types of movement of the machine 10, such as vertical movement and pitch of the machine. In doing so, the controller 41 may be configured to receive as input values the amplitudes of movement of the machine 10 at certain frequencies. Maps of responses to movement of the machine 10 may be established and stored within the controller 41. Such maps may utilize various factors including the speed of the machine 10, the amplitude of the movements, and the frequencies of the movements. Other operating conditions and characteristics of the machine 10 may also be related in the data maps.

During the operation of the machine 10, as described in more detail below, the ride control functionality of control system 40 may modify the position of one or more implements 16 to eliminate or reduce the vertical movement or pitch of the machine 10. Once the vertical movement or pitch has been sufficiently eliminated or reduced, the ride control functionality of the control system 40 may be disengaged and no longer affects the position of the implement so that the position of the implement may be returned to that directed by the operator.

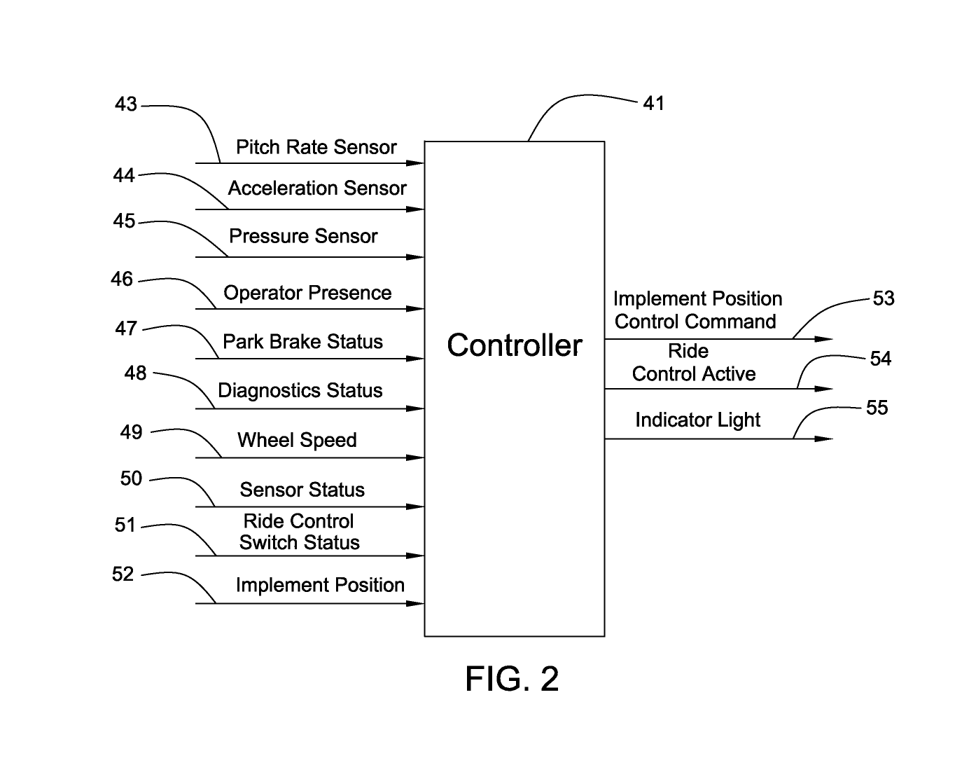

As depicted in FIG. 2, the controller 41 receives information from various sensors and systems of the machine 10 and processes this information. At node 43, the controller 41 may receive a signal or signals from first sensor 33 indicative of the pitch rate of the machine 10. Controller 41 may receive, at a node 44, a vertical acceleration signal or signals from second sensor 34 indicative of the vertical acceleration of the machine 10. At node 45, the controller 41 may receive a signal as to the pressure within a hydraulic cylinder associated with the implement 16. At node 46, the controller 41 may receive a signal as to whether an operator is seated within the cab 14. The operator presence signal may be provided by operator presence sensor 30.

The controller 41 may receive a signal at node 47 as to whether the parking brake is engaged. The parking brake signal may be provided by a parking brake sensor 31. At node 48, the controller 41 may receive a signal as to the status of certain diagnostics of the ride control system. At node 49, the controller 41 may receive a signal indicative of the wheel speed of the wheels 13. The wheel speed signal may be provided by the wheel speed sensor 32. At node 50, the controller 41 may receive a signal as to the status of the various sensors that provide information to the ride control system. For example, if a pitch rate sensor, an acceleration sensor or implement position sensor fault is reported, the system may disable and send an indication to the operator. At node 51, the controller 41 may receive a signal from a user interface 35 as to whether the operator has engaged or disengaged the ride control system. At node 52, the controller 41 may receive a signal from the position sensors 23 indicative of the position of implement 16.

In one embodiment, the controller 41 may generate various output signals based upon the operation of the ride control system. At node 53, the controller 41 may provide a command signal such as an implement position control command to control the operation and positioning of the implement. The controller 41 may provide a signal at node 54 to communicate to other aspects of the control system 40 the status of the ride control system. At node 55, the controller 41 may provide a signal to an indicator light (not shown) indicating whether the ride control functionality is in operation. For example, if the machine 10 is not experiencing sufficient movement for the ride control system to be moving the implement, the light may be off. If the ride control functionality is operating, the light may be illuminated. If the machine 10 is moving vertically or pitching but the ride control functionality is not operating, the light may be flashing. An example of when the machine 10 may be in such a condition but the ride control functionality is not operating includes when the operator has turned off the ride control functionality. Another example may be when other systems of the machine 10 that control the implement position have a higher priority and take precedence over the ride control functionality. For example, operator issued commands may take priority over controller generated commands. As such, if only a limited amount of power is available, the system may implement the commands from the operator rather than divert power to move the implement and operate the ride control system.

Machine 10 may be equipped with a user interface 35 to activate and deactivate the ride control system of the control system 40. The user interface 35 may take the form of a switch, a touch screen or any other desired component. If the user interface 35 is not activated, the ride control functionality of the machine 10 will be inoperative regardless of the operating conditions encountered by the machine.

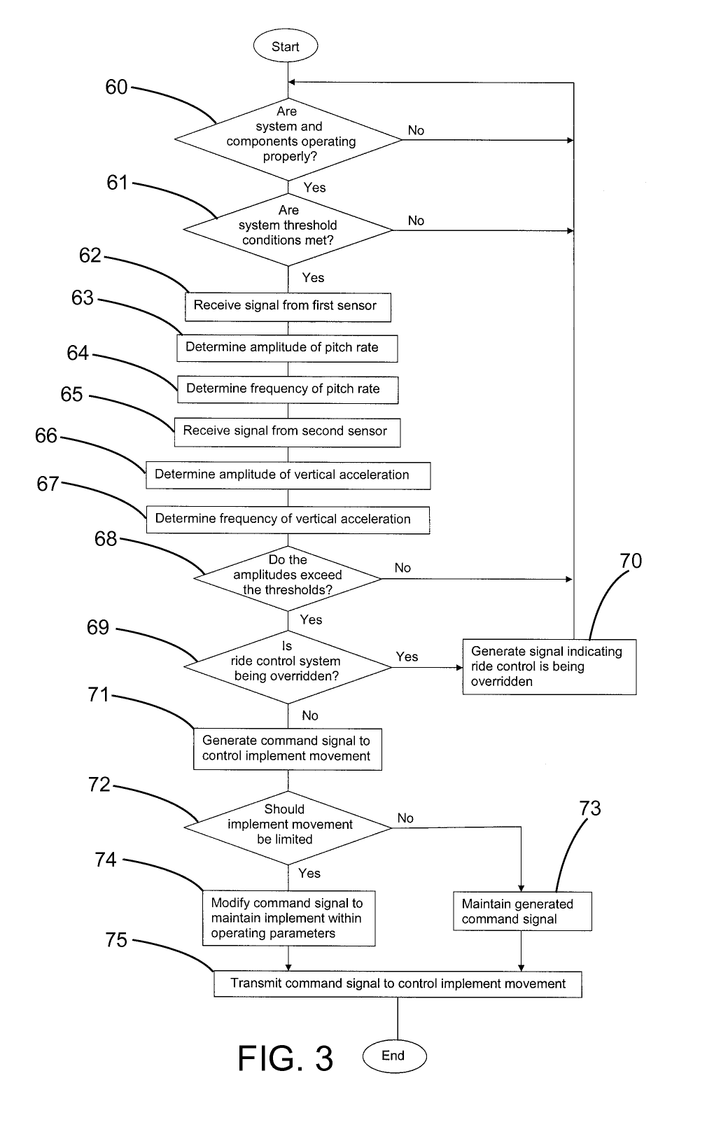

If the user interface 35 is activated, the ride control functionality of the control system 40 may operate in accordance with the flow chart of FIG. 3. The controller 41 may initially perform various diagnostic and system checks at stage 60 to confirm that the ride control system and components of the machine 10 are operating properly. These diagnostics would include checking for reported faults of sensing devices. Additionally parameters such as engine speed, engine torque requirements, or wheel speed may be used as threshold conditions for enablement. EXAMPLES?? If any aspects of the system or components of machine 10 are not operating properly, controller 41 may not activate the ride control functionality and the machine 10 may operate in accordance with the operator's commands.

At stage 61, the controller 41 determines whether certain threshold conditions of the ride control system have been met. For example, the ride control functionality may only be operative under certain operating conditions of the machine 10. One operating condition may be that the machine is operating above a predetermined speed. An additional operating condition may be that the machine is operating in a forward direction. Additional required operating conditions may include the presence of an operator in the operator's seat and the disengagement of the parking brake.

The system may be configured so that the ride control functionality will be inoperative if any of the threshold conditions are not met. In other circumstances, the ride control functionality may be limited or otherwise adjusted depending on which threshold conditions have not been met.

If the system threshold conditions have been met at stage 61, the controller 41 may receive at stage 62 a pitch rate signal or signals from the first sensor 33 indicative of the pitch rate of the machine 10. The controller 41 may determine, at stage 63, the amplitude of the pitch rate of the machine 10 based upon the pitch rate signal. At stage 64, the controller may determine the frequency or frequencies of the movement that make up the pitch rate. In other words, in some situations, the pitch rate amplitude may be made up of movement at more than one frequency. In other instances, the first sensor 33 may provide to the controller 41 a signal that includes the amplitude and the frequency or frequencies of the pitch rate.

At stage 65, the controller 41 receives a vertical acceleration signal or signals from the second sensor 34 indicative of the vertical acceleration of the machine 10. The controller 41 determines, at stage 66, the amplitude of the vertical acceleration of the machine 10. At stage 67, the controller determines the frequency or frequencies of the movement that make up the vertical acceleration. The amplitude of the vertical acceleration may be made up of movement at more than one frequency. In other instances, the second sensor 34 may provide to the controller 41 a signal that includes the amplitude and the frequency or frequencies of the vertical acceleration.

At stage 68, the controller determines whether the amplitudes of movement exceed a predetermined threshold or thresholds. For example if the pitch rate exceeds one degree per second, the controller 41 may then issue an implement command to counteract the motion of the machine 10. In one example, this may be carried out by comparing the amplitude of the pitch rate to data maps within the controller 41. Such comparison may be based upon the frequency or frequencies of the pitch rate. In another example, the amplitude of the vertical acceleration may be compared to data maps within the controller 41. Such comparison may be based upon the frequency or frequencies of the vertical acceleration. Still further, the combination of the amplitude of the pitch rate and the amplitude of the vertical acceleration may be compared to data maps within the controller 41. As such, the controller 41 may analyze the amplitudes both individually and in view of each other. If the neither the amplitude of the pitch rate, the amplitude of the vertical acceleration nor the combination of the two amplitudes exceed predetermined thresholds, the ride control functionality may not be activated and the machine 10 will operate in accordance with the operator's commands as the pitch rate and vertical acceleration encountered are insufficient to warrant the activation of the ride control system.

If the pitch rate, the vertical acceleration or the combination of the two exceed the predetermined thresholds, the controller 41 may determine at stage 69 whether any other subsystems within control system 40 have priority over the ride control functionality. If the ride control functionality is being overridden such as by a user interface switch or by an operator issued command overriding a controller generated command, the machine 10 will operate without the ride control functionality. The controller may, at stage 70, generate a signal indicating that the ride control functionality has been overridden. This may be indicated by a flashing indicator light within the cab 14.

If the ride control functionality is not being overridden at stage 69, the controller may, at stage 71, determine the appropriate movement of the implement 16 to eliminate or reduce the pitch and/or vertical movement and generate an appropriate command signal to carry out such movement. In one example, the controller 41 may generate a command signal to raise or lower the implement and thus control its vertical movement. In another example, the command signal from the controller 41 may rotate the implement 16 and thus control its angular movement. In some situations, it may be desirable to both rotate and change the vertical height of the implement 16. The command signal generated by the controller 41 may be based upon the operating conditions of the machine 10, the load on or within implement 16 as well as the amplitude and frequency of the pitch rate and vertical acceleration. For example, the controller 41 may adjust the rate of movement to move the implement 16 substantially more quickly to counteract a relatively large movement of machine 10 as compared to that required for a relatively small movement of the machine 10. After generating the command signal, controller 41 may transmit the command signal to the appropriate system at stage 72 to change the position of the implement.

It should be noted that, as described above, machine 10 may experience two different types of movement (i.e., pitch and vertical) and at multiple frequencies. In other words, pitch may occur at one or more frequencies at the same time as vertical movement occurs at one or more frequencies. It should be noted that the two types of movement may not occur at identical frequencies. The data maps of controller 41 may contain data for each type of movement and at multiple frequencies and the process set forth in FIG. 3 may be repeated (simultaneously or sequentially) for each type of movement.

In an alternate configuration, the controller 41 may determine a command signal to reduce or eliminate each type of movement but only transmit the command signal to reduce one of the movements. For example, the controller 41 may prioritize the movements based upon relative amplitudes of movement. In another example, one type of movement may be deemed more detrimental than another so that the controller 41 may prioritize the generation of command signals to reduce or eliminate one particular type of movement first. In still another alternate configuration, the controller 41 may determine, based upon the operating conditions and input from the sensors, that an alternate or blended solution may be desirable to reduce or eliminate the pitch and vertical movement. Still further, the controller 41 may generate a command signal that reduces each type of movement without immediately eliminating either type of movement.

The controller 41 may operate by issuing a series of commands to generate movement of the implement 16 rather than a single command. More specifically, the controller 41 may continuously monitor the movement of the machine 10 and calculate movement of the implement 16 to cause the machine 10 to move generally opposite the measured movement (in terms of amplitude, frequency or both) of the machine 10. As such, the controller 41 may operate in a somewhat iterative manner in which machine movement caused by movement of the implement 16 and machine movement as measured by the first sensor 33 and the second sensor 34 will tend to cancel each other out and produce a smoother ride.

At stage 72, the controller 41 determines whether movement of the implement 16 should be limited in view of the generated command signal. For example, boundaries of movement of the implement may be set within the controller 41. More specifically, if the implement 16 is relatively close to the ground and the command signal would result in downward movement of the implement, the controller 41 may be configured to limit the downward movement of the implement 16 to prevent engagement with the ground. In another example, the implement 16 may be close to its upper limit of travel and the command signal would result in upward movement of the implement. In such case, the controller 41 may be configured to limit and/or slow the upward movement of the implement 16 adjacent the upper limit of travel. Still further, certain commanded movements may be outside a typical range or frequency of expected movements and thus may be limited by the controller 41.

In still another example, movement of the implement 16 may be dependent to some extent on whether the implement is in a loaded/full or unloaded/empty condition. Some actions, such as tilting of the implement 16, may be desirable to control movement of the machine 10 when the implement is empty yet avoided when the implement is full to prevent losing or otherwise displacing a load. In another example, the machine 10 may be operating at a maximum speed with the engine 12 operating at its maximum output. Certain commanded movements of the implement 16 (e.g., raising the implement) may cause power to be diverted from the drivetrain to moving the implement. Accordingly, under some conditions, the controller 41 may be configured to reduce or override the command signal based upon other operating conditions of the machine 10.

If the movement of the implement 16 does not need to be limited at stage 72, the controller 41 does not change the generated command signal and maintains such command signal at stage 73. The command signal is transmitted at stage 75 to control movement of the implement 16.

If the controller 41 determines at stage 72 that movement of the implement 16 should be limited, the controller will modify at stage 74 the command signal to generate a modified command signal to limit the travel of the implement 16. As such, the implement 16 will be maintained within a desired range of movement and will not be moved to an undesirable position. This modified command signal is transmitted at stage 75 to control the movement of the implement 16.

After the pitch and vertical movement have been reduced or eliminated by the ride control system, the controller 41 may be configured to return the implement 16 to the position at which it was located prior to the operation of the ride control functionality. For example, the controller 41 may be configured to return the implement 16 to its original position if it is more than a certain distance or percentage of travel from its original position. In one example, the controller 41 may return the implement 16 to its original position if the implement has been displaced more than 10% from its original position. Other percentages or specific distances may also be used.

### INDUSTRIAL APPLICABILITY

The industrial applicability of the system described herein will be readily appreciated from the foregoing discussion. The foregoing discussion is applicable to machines 10 such as wheel loaders for which pitch and vertical acceleration may affect their operation. Individual characteristics of the machine as well as the operating conditions and environment affect the movement of the machine. The ride control system disclosed herein may determine the pitch rate and/or vertical acceleration of the machine and reduce or eliminate such movement by changing the position of the implement based upon various factors such as the amplitudes and frequencies of the movement, as well as the operating conditions and other factors.

In some applications, it may be desirable to create a hybrid system that utilizes the electro-hydraulic ride control system herein together with one or more accumulators (not shown) within the electro-hydraulic system. In systems that rely on the use of accumulators for ride control, the systems are typically “tuned” to operate at certain speeds, frequencies and loads that are either expected to be encountered or that would be problematic without the ride control functionality. In a hybrid system having both an electro-hydraulic ride control system and one or more accumulators, such a system may improve the ride control functionality over a wide variety of machine speeds, vertical acceleration and pitch frequencies, and machine loads. In one example, such a hybrid system may rely on one or more accumulators to provide ride control functionality at certain speeds, frequencies, and loads, and rely upon the electro-hydraulic ride control system to supplement the ride control functionality at other speeds, frequencies, and loads.

In one aspect, a system for automated control of movement of a machine includes an implement configured for movement relative to the machine, a system for moving the implement relative to the machine, and a pitch rate sensor configured to provide a pitch rate signal indicative of a pitch rate of the machine. A controller 41 is configured to receive the pitch rate signal from the pitch rate sensor and determine a pitch rate of the machine based upon the pitch rate signal. The controller 41 is further configured to generate a command signal to move the implement at least in part based upon the pitch rate to control the pitch rate of the machine, and transmit the command signal to control movement of the implement and to control the pitch rate of the machine.

In another aspect, a machine has an implement configured for movement relative to the machine, a system for moving the implement relative to the machine, and a pitch rate sensor configured to provide a pitch rate signal indicative of a pitch rate of the machine. A controller implemented method includes receiving the pitch rate signal from the pitch rate sensor, and determining a pitch rate of the machine based upon the pitch rate signal. A command signal is generated to move the implement at least in part based upon the pitch rate to control the pitch rate of the machine, and the command signal is transmitted to control movement of the implement and to control the pitch rate of the machine.

In still another aspect, a machine includes a prime mover, an implement configured for movement relative to the machine, a system for moving the implement relative to the machine, and a pitch rate sensor configured to provide a pitch rate signal indicative of a measured pitch rate of the machine. A controller 41 is configured to receive the pitch rate signal from the pitch rate sensor and determine a pitch rate of the machine based upon the pitch rate signal. The controller 41 is further configured to generate a command signal to move the implement at least in part based upon the pitch rate to control the pitch rate of the machine, and transmit the command signal to control movement of the implement and to control the pitch rate of the machine.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A system for automated ride control of a machine, the machine including an implement configured for movement relative to the machine, the system comprising:
a system for moving the implement relative to the machine;
a pitch rate sensor configured to provide a pitch rate signal indicative of a pitch rate of the machine, the pitch rate including an amplitude and a frequency corresponding to the amplitude of the pitch rate; and
a controller configured to:
receive the pitch rate signal from the pitch rate sensor;
determine a pitch rate of the machine including the amplitude and the frequency corresponding to the amplitude of the pitch rate based upon the pitch rate signal;
generate a command signal to move the implement at least in part based upon the amplitude and the frequency of the pitch rate to control the pitch rate of the machine; and
transmit the command signal to control movement of the implement and to control the pitch rate of the machine.

2. The system of claim 1, wherein the command signal controls movement of the implement and a rate of movement of the implement.

3. The system of claim 2, wherein the controller is configured to control vertical movement and angular movement of the implement.

4. (canceled)

5. The system of claim 1, wherein the pitch rate sensor is disposed on a chassis of the machine.

6. The system of claim 1, wherein the pitch rate sensor is disposed on a frame member of the implement.

7. The system of claim 1, wherein the system further includes an acceleration sensor configured to provide an acceleration signal indicative of an acceleration of the machine, and the controller is further configured to:
receive the acceleration signal from the acceleration sensor;
determine an acceleration of the machine based upon the acceleration signal; and
generate the command signal to move the implement at least in part based upon the acceleration of the machine.

8. The system of claim 7, wherein the pitch rate sensor and the acceleration sensor are disposed on a chassis of the machine,

9. The system of claim 7, wherein the pitch rate sensor and the acceleration sensor are disposed on a frame member of the implement.

10. The system of claim 7, wherein the controller is further configured to determine an amplitude of the acceleration and a frequency of the acceleration corresponding to the amplitude of the acceleration.

11. The system of claim 10, wherein the frequency of the acceleration corresponding to the amplitude of the acceleration and the frequency of the pitch rate corresponding to the amplitude of the pitch rate are different.

12. A controller implemented method of controlling movement of a machine, the machine having an implement configured for movement relative to the machine, a system for moving the implement relative to the machine, and a pitch rate sensor configured to provide a pitch rate signal indicative of a pitch rate of the machine, the pitch rate including an amplitude and a frequency corresponding to the amplitude of the pitch rate, the method comprising:
receiving the pitch rate signal from the pitch rate sensor;
determining a pitch rate of the machine based upon the pitch rate signal, the pitch rate including the amplitude and the frequency corresponding to the amplitude;
generating a command signal to move the implement at least in part based upon the amplitude and the frequency of the pitch rate to control the pitch rate of the machine; and
transmitting the command signal to control movement of the implement and to control the pitch rate of the machine.

13. The controller implemented method of claim 12, further including controlling movement of the implement and a rate of movement of the implement.

14. The controller implemented method of claim 13, further including controlling vertical movement and angular movement of the implement

15. (canceled)

16. The controller implemented method of claim 12, wherein the system further includes an acceleration sensor configured to provide an acceleration signal indicative of an acceleration of the machine, and further comprising:
receiving the acceleration signal from the acceleration sensor;
determining an acceleration of the machine based upon the acceleration signal; and
generating the command signal to move the implement at least in part based upon the acceleration of the machine.

17. A machine comprising:
a prime mover;
an implement configured for movement relative to the machine;
a system for moving the implement relative to the machine;
a pitch rate sensor configured to provide a pitch rate signal indicative of a pitch rate of the machine, the pitch rate including an amplitude and a frequency corresponding to the amplitude of the pitch rate; and
a controller configured to:
receive the pitch rate signal from the pitch rate sensor;
determine a pitch rate of the machine including the amplitude and the frequency corresponding to the amplitude of the pitch rate based upon the pitch rate signal;
generate a command signal to move the implement at least in part based upon the amplitude and the frequency of the pitch rate to control the pitch rate of the machine; and
transmit the command signal to control movement of the implement and to control the pitch rate of the machine.

18. The machine of claim 17, wherein the command signal controls movement of the implement and a rate of movement of the implement.

19. The machine of claim 18, wherein the controller is configured to control vertical movement and angular movement of the implement.

20. The machine of claim 17, wherein the machine further includes an acceleration sensor configured to provide an acceleration signal indicative of an acceleration of the machine, and the controller is further configured to:
receive the acceleration signal from the acceleration sensor;
determine an acceleration of the machine based upon the acceleration signal; and
generate the command signal to move the implement at least in part based upon the acceleration of the machine.

21. The system of claim 1, wherein the controller is further configured to limit movement of the implement to prevent engagement between the implement and a ground surface.

22. The controller implemented method of claim 12, further including limiting movement of the implement to prevent engagement between the implement and a ground surface.
